(19) United States
(12) Patent Application Publication
(10) Pub. No.: US 2006/0034507 A1
(43) Pub. Date: Feb. 16, 2006

(54) A method, process and computer program to automatically create a customized three-dimensional nail object by library reference

(76) Inventors: Scott L. Nielson, Layton, UT (US); Craig P. Gifford, West Jordan, UT (US)

Correspondence Address: MARKS & CLERK, P.O. BOX 957, STATION B, OTTAWA, ON, K1P 5S7, CA

(21) Appl. No.: 10/710,971

(22) Filed: Aug. 16, 2004

(51) Int. Cl. G06K 9/00

(52) U.S. Cl. 382/154

(57) ABSTRACT

The invention is a method, process and computer program to automatically create a customized three-dimensional artificial nail object by library reference based upon an actual/existing digitized nail surface. This particular invention generates the overall desired three-dimensional nail object by taking measurement reference points of the digitized nail surface and selecting an appropriate finished three-dimensional artificial nail object that matches the reference points thus creating a preferred artificial nail object. The application of the invention results in a wide scope of possible implementations including a use for creating artificial fingernails and artificial toenails.

### CROSS REFERENCE TO RELATED APPLICATIONS

This application references U.S. patent application Ser. No. 10/708,065, filed Feb. 6, 2004.

### BACKGROUND OF INVENTION

While working with fingernails and fingernail objects for several years, there was no easy way to automatically create a three-dimensional model of an artificial fingernail object. In fact, most software in the market allows a user to manually manipulate and create just about any three-dimensional object conceivable, but the process of doing this manually is very time consuming and allows for too much human error when creating artificial fingernails with a consistent and reliable appearance. Because of this the inventors set out to find a method to create artificial fingernail objects automatically and this invention was the result.

One simple way to create the desired artificial nail object is to establish a library of three-dimensional nail objects with subtle variations along the X-axis, Y-axis and Z-axis.

This library can then be easily accessed and the desired nail object file utilized in any circumstance where an existing digitized nail surface area matches the parameters of the library nail object.

By creating a variety of three-dimensional nail objects, the inventors were able to successfully establish a library that makes it simple and easy to rapidly create a customized three-dimensional nail object for any purpose.

The advantage of this invention is that with relative ease and very little labor a desired customized and preferred three-dimensional artificial nail object can be created.

This invention has many applications, particularly with fingernail and toenails.

This new desired three-dimensional object has many applications, not the least of which is the ability to physically create the nail object for the individual and supply them with an artificial nail for use as a cosmetic or even prosthesis. The invention can now save time and virtually guarantee consistent looking fingernail objects, all accomplished with relative ease.

### SUMMARY OF INVENTION

The invention is a method, process and computer program to automatically create a customized three-dimensional artificial nail object by library reference based upon an actual/existing digitized nail surface. This particular invention generates the overall desired three-dimensional nail object by taking measurement reference points of the digitized nail surface and selecting an appropriate finished three-dimensional artificial nail object that matches the reference points thus creating a preferred artificial nail object. The application of the invention results in a wide scope of possible implementations including a use for creating artificial fingernails and artificial toenails.

### BRIEF DESCRIPTION OF DRAWINGS

FIG. 1 is a diagram demonstrating the Axis, periphery and digitizing of the nail surface object.

FIG. 2 is a diagram illustrating the library selection process and combining of the digitized nail surface with the library selected nail object.

FIG. 3 is a diagram showing the new customized nail object fitting over the digitized surface.

### DETAILED DESCRIPTION

By starting with an existing digitized three-dimensional surface point array of an actual fingernail or toenail, the invention permits the automatic creation of a new customized three-dimensional object that will fit over the actual fingernail or toenail. This is accomplished by measuring key points of data contained in the digitized array.

The key points are measurement values in millimeters or inches along the X-axis, Y-axis and Z-axis. Further, the arcs and curves of the digitized nail surface are also determined along the X-axis and Y-axis. Additional key points are found in the periphery points along the digitized nail surface.

Once the key points are evaluated, a selection process is handled whereby preexisting representations of three-dimensional nail objects are compared from a library of existing three-dimensional nail objects; and the best comparable nail object that also represents the desired overall appearance is then manipulated and utilized.

In order to successfully create the desired customized nail object an additional step is necessary to customize the bottom fit of the new library selected nail object. This is achieved by aligning the digitized nail surface with the bottom of the library selected nail object. Where the two objects intersect, the three-dimensional points of the digitized nail surface are used and the intersecting points of the library select nail object are dropped, thus combining the two three-dimensional objects into one.

To insure a custom fit, the periphery points are evaluated, and in any instant where the library selected nail object point array overhangs the cuticle end of the digitized nails surface, they are dropped and the remaining points are combined with the digitized nail surface to create a customized three-dimensional representation of the cuticle fitting which will allow the finished three-dimensional nail object to fit over the digitized nail surface. Likewise, any time voids occur (where the library selected nail object file doesn't have enough points to match the digitized nail surface cuticle periphery), three-dimensional points are added to the library selected nail object so that it fits the entire customized cuticle periphery. The result is a new customized three-dimensional nail object that has the desired appearance and will fit over the digitized nail surface.

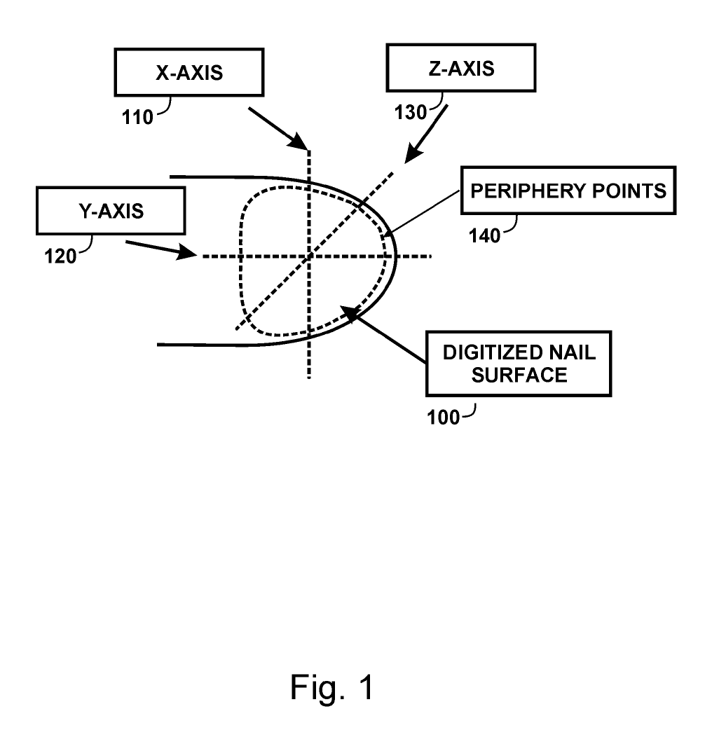

In FIG. 1 the first step of the process is demonstrated, where a digitized nail surface 100 is shown and the orientation of the X, Y and Z Axis is established. Here the X-axis 110 is found along the width of the digitized nail surface 100; the Y-axis 120 is the length of the digitized nail surface 100 and can be determined initially by measuring from the cuticle to the tip of the digitized nail surface 100; and the Z-axis 130 represents the height or depth of the digitized nail surface 100. Additionally, the periphery points 140 of the digitized nail surface 100 are also determined in the first step to insure that the digitized nail surface 100 dimensions will fit into the library selected nail object 200. All of these reference points are utilized in the selection process for the library selected nail object 200, which will eventually be manipulated to create the new three-dimensional data representing the final three-dimensional customized nail object 210.

Measuring the digitized surface area includes creating a relationship of the X-axis 110, Y-axis 120 and Z-axis 130 to millimeters or inches, further arcs and curves of the digitized nail surface 100 are determined by measuring and creating relationships between the three-dimensional points of data along the X-axis 110, Y-axis 120 and Z-axis 130. These curves and arcs are utilized and manipulated during the library nail selection object 200 process, in an effort to make the customized nail object 210.

Once the library selected nail object 200 is determined, the digitized nail surface 100 is aligned to the bottom surface of the library selected nail object 200. At the intersection of the two three-dimensional object arrays, every point of intersection of the library selected nail object 200 will be dropped to give way to the intersecting points of the digitized nail surface 100, thus creating a customized fit along the bottom of the customized nail object 210.

By utilizing the periphery points 140 along the cuticle of the digitized nail surface 100 as reference points, any voids or overhangs will be handled. In the event of an overhang of points in the library selected nail object 200, those points that exist beyond the digitized nail surface 100 will be dropped so that the library selected nail object 200 will align along the curves of the cuticle. In the event of a void, meaning that the library selected nail object 200 is missing a point that should exist to match with the cuticle points of the digitized nail surface 100, those points will be created in the library selected nail object 200 so that the library selected nail object 200 will align along the curves of the cuticle.

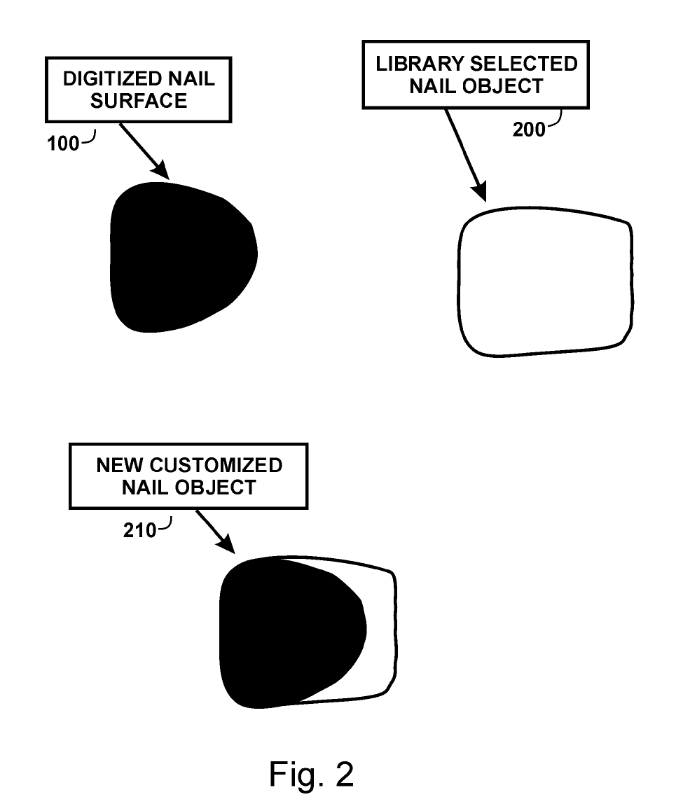

FIG. 2 shows the combination of the library selected nail object 200 with the digitized nail surface 100 thus creating a new customized nail object 210.

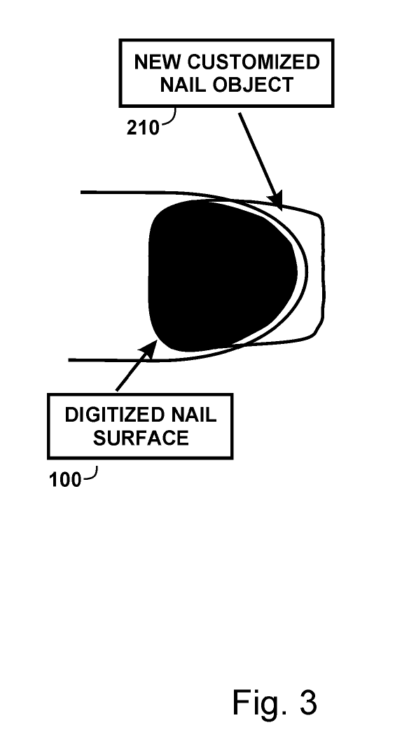

FIG. 3 shows the new customized nail object 210 fitting over the top of the original digitized nail surface 100.

By completing the steps above, virtually any software program or user would be capable of creating a desired and customized three-dimensional artificial nail object. The entire objective of the preferred embodiments of the invention has been to create a simplified method, process and computer program to automatically create a customized three-dimensional nail object by referring to a library of preexisting nail objects and combining the best comparable of the library with an existing nail surface into a preferred artificial nail object. The application of this invention is extensive and plentiful, as with this invention it will become trivial to generate desired three-dimensional artificial nail objects by automation quickly and easily. Because of the advantages inherent in this invention it is anticipated that many variants of this invention are possible, which should be included within the preferred embodiments and descriptions of this invention.

1. A method to automatically create a three-dimensional nail object, comprising:
starting with a three-dimensional array of data representing a digitized nail surface, and;
measuring key reference points along the X-axis, Y-axis, Z-axis and the periphery of the digitized nail surface, and;
selecting a preexisting preferred finished three-dimensional nail object point array that closely matches the key reference points along the X-axis, Y-axis and Z-axis from a library of pre-created three-dimensional nail object arrays, and;
combining the preferred three-dimensional nail object with the digitized nail surface into a new preferred three-dimensional artificial nail object that conforms to an expected result so that the new generated nail object will fit over the digitized nail surface and create a desired artificial nail appearance.

2. The method of claim 1, wherein starting with a three-dimensional array of data representing a digitized nail surface includes any data that can be used to represent a three-dimensional object.

3. The method of claim 1, wherein the three-dimensional array of data may be represented as points of data representing an X-axis, Y-axis and Z-axis. The three-dimensional array of data may also include the points defining the periphery of the digitized nail surface.

4. The method of claim 1, wherein measuring key reference points includes determining the measurement value in millimeters or inches of the nail surface along its X-axis, Y-axis and Z-axis; where X-axis represents width, Y-axis represents the length and Z-axis represents depth.

5. The method of claim 1, wherein measuring key reference points includes determining the arc of the digitized nail surface along the X-axis and/or determining the arc of the nail surface along the Y-axis.

6. The method of claim 1, wherein measuring key reference points includes evaluating three-dimensional points along the periphery of the nail surface.

7. The method of claim 1, wherein selecting a preexisting finished three-dimensional array of points resembling a preferred nail object includes using the reference points to select and modify an existing finished nail object array from a library of said arrays, containing many variations along the X-axis, Y-axis, and Z-axis. The three-dimensional library nail object arrays would appear in every way to be a finished and desired artificial nail object.

8. The method of claim 1, wherein combining the library selected nail object array of points with the digitized nail surface includes aligning the digitized nail surface along the bottom surface of the library selected nail object, inasmuch as anywhere that the digitized nail surface intersects the library selected nail object, the digitized nail surface becomes the bottom surface of the library selected nail object.

9. The method of claim 1, wherein combining the library selected nail object with the digitized nail surface includes removing any points of the library selected object around the periphery points of the digitized nail surface so that the library selected nail object will fit directly on top of the digitized nail surface, and eventually fit the digitized nail surface without any voids or points extending beyond the digitized nail surface.

10. The method of claim 1, wherein the combining of the library selected nail object and the digitized nail surface will form a new preferred three-dimensional artificial nail object.

11. The method of claim 1, wherein the desired nail object in its final state is a customized three-dimensional object representing an artificial nail that is desired, which fits over the digitized nail surface.

12. A process to automatically create a three-dimensional nail object, comprising:
starting with a three-dimensional array of data representing a digitized nail surface, and;
measuring key reference points along the X-axis, Y-axis, Z-axis and the periphery of the digitized nail surface, and;
selecting a preexisting preferred finished three-dimensional nail object point array that closely matches the key reference points along the X-axis, Y-axis and Z-axis from a library of pre-created three-dimensional nail object arrays, and;
combining the preferred three-dimensional nail object with the digitized nail surface into a new preferred three-dimensional artificial nail object that conforms to an expected result so that the new generated nail object will fit over the digitized nail surface and create a desired artificial nail appearance.

13. The process of claim 12, wherein starting with a three-dimensional array of data representing a digitized nail surface includes any data that can be used to represent a three-dimensional object.

14. The process of claim 12, wherein the three-dimensional array of data may be represented as points of data representing an X-axis, Y-axis and Z-axis. The three-dimensional array of data may also include the points defining the periphery of the digitized nail surface.

15. The process of claim 12, wherein measuring key reference points includes determining the measurement value in millimeters or inches of the nail surface along its X-axis, Y-axis and Z-axis; where X-axis represents width, Y-axis represents the length and Z-axis represents depth.

16. The process of claim 12, wherein measuring key reference points includes determining the arc of the digitized nail surface along the X-axis and/or determining the arc of the nail surface along the Y-axis.

17. The process of claim 12, wherein measuring key reference points includes evaluating three-dimensional points along the periphery of the nail surface.

18. The process of claim 12, wherein selecting a preexisting finished three-dimensional array of points resembling a preferred nail object includes using the reference points to select and modify an existing finished nail object array from a library of said arrays, containing many variations along the X-axis, Y-axis, and Z-axis. The three-dimensional library nail object arrays would appear in every way to be a finished and desired artificial nail object.

19. The process of claim 12, wherein combining the library selected nail object array of points with the digitized nail surface includes aligning the digitized nail surface along the bottom surface of the library selected nail object, inasmuch as anywhere that the digitized nail surface intersects the library selected nail object, the digitized nail surface becomes the bottom surface of the library selected nail object.

20. The process of claim 12, wherein combining the library selected nail object with the digitized nail surface includes removing any points of the library selected object around the periphery points of the digitized nail surface so that the library selected nail object will fit directly on top of the digitized nail surface, and eventually fit the digitized nail surface without any voids or points extending beyond the digitized nail surface.

21. The process of claim 12, wherein the combining of the library selected nail object and the digitized nail surface will form a new preferred three-dimensional artificial nail object.

22. The process of claim 12, wherein the desired nail object in its final state is a customized three-dimensional object representing an artificial nail that is desired, which fits over the digitized nail surface.

23. A computer program to automatically create a three-dimensional nail object, comprising:
starting with a three-dimensional array of data representing a digitized nail surface, and;
measuring key reference points along the X-axis, Y-axis, Z-axis and the periphery of the digitized nail surface, and;
selecting a preexisting preferred finished three-dimensional nail object point array that closely matches the key reference points along the X-axis, Y-axis and Z-axis from a library of pre-created three-dimensional nail object arrays, and;
combining the preferred three-dimensional nail object with the digitized nail surface into a new preferred three-dimensional artificial nail object that conforms to an expected result so that the new generated nail object will fit over the digitized nail surface and create a desired artificial nail appearance.

24. The computer program of claim 23, wherein starting with a three-dimensional array of data representing a digitized nail surface includes any data that can be used to represent a three-dimensional object.

25. The computer program of claim 23, wherein the three-dimensional array of data may be represented as points of data representing an X-axis, Y-axis and Z-axis. The three-dimensional array of data may also include the points defining the periphery of the digitized nail surface.

26. The computer program of claim 23, wherein measuring key reference points includes determining the measurement value in millimeters or inches of the nail surface along its X-axis, Y-axis and Z-axis; where X-axis represents width, Y-axis represents the length and Z-axis represents depth.

27. The computer program of claim 23, wherein measuring key reference points includes determining the arc of the digitized nail surface along the X-axis and/or determining the arc of the nail surface along the Y-axis.

28. The computer program of claim 23, wherein measuring key reference points includes evaluating three-dimensional points along the periphery of the nail surface.

29. The computer program of claim 23, wherein selecting a preexisting finished three-dimensional array of points resembling a preferred nail object includes using the reference points to select and modify an existing finished nail object array from a library of said arrays, containing many variations along the X-axis, Y-axis, and Z-axis. The three-dimensional library nail object arrays would appear in every way to be a finished and desired artificial nail object.

30. The computer program of claim 23, wherein combining the library selected nail object array of points with the digitized nail surface includes aligning the digitized nail surface along the bottom surface of the library selected nail object, inasmuch as anywhere that the digitized nail surface intersects the library selected nail object, the digitized nail surface becomes the bottom surface of the library selected nail object.

31. The computer program of claim 23, wherein combining the library selected nail object with the digitized nail surface includes removing any points of the library selected object around the periphery points of the digitized nail surface so that the library selected nail object will fit directly on top of the digitized nail surface, and eventually fit the digitized nail surface without any voids or points extending beyond the digitized nail surface.

32. The computer program of claim 23, wherein the combining of the library selected nail object and the digitized nail surface will form a new preferred three-dimensional artificial nail object.

33. The computer program of claim 23, wherein the desired nail object in its final state is a customized three-dimensional object representing an artificial nail that is desired, which fits over the digitized nail surface.
